(19) United States
(12) Patent Application Publication
(10) Pub. No.: US 2026/0222464 A1
(43) Pub. Date: Jul. 30, 2026

(54) MULTIMEDIA SUBPROTOCOLS OVER REAL TIME PROTOCOL

(71) Applicant: Lenovo (Singapore) Pte. Ltd., Singapore (SG)

(72) Inventor: RAZVAN-ANDREI STOICA, Nordrhein-Westfalen (DE)

(73) Assignee: Lenovo (Singapore) Pte. Ltd., Singapore (SG)

(21) Appl. No.: 19/146,195

(22) PCT Filed: Jan. 7, 2024
(86) PCT No.: PCT/IB2024/050135

§ 371 Date: Jul. 7, 2025

Related U.S. Application Data
(60) Provisional application No. 63/478,932, filed on Jan. 7, 2023.

(51) Int. Cl. H04L 65/65; H04L 65/1069; H04L 65/401

(52) U.S. Cl. CPC H04L 65/65; H04L 65/1069; H04L 65/4015

(57) ABSTRACT

Various aspects of the present disclosure relate to devices and methods for wireless communication that support real-time communication data for multiple types of non-audiovisual content in addition to audiovisual media content with payload communicating devices functioning as one of a payload transmitting device and a payload receiving device. A payload transmitting device includes at least one processor that executes at least one user interface application that generates real-time communication data. The processor determines subprotocol format(s) of a real-time protocol that corresponds respectively to at least one of audiovisual media content and non-audiovisual content of the real-time communication data. The processor establishes a communication link for a real-time data exchange session with a payload receiving device. The processor encapsulates the real-time communication data into real-time payload, using the subprotocol format(s). The processor transmits the real-time payload to the payload receiving device.

### PRIORITY APPLICATION

This application claims priority to U.S. provisional application No. 63/478,932, filed Jan. 7, 2023.

### TECHNICAL FIELD

The present disclosure relates to wireless communications, and more specifically to transmitting and receiving real time content using wireless communication.

### BACKGROUND

A wireless communications system may include one or multiple network communication devices, including base stations, which may be otherwise known as a long-term evolution base node (eNodeB or eNB), a next-generation base node (NodeB or gNB), or other suitable terminology. Each network communication device, such as a base station, may support wireless communications for one or multiple user communication devices, which may be otherwise known as user equipment (UE), or other suitable terminology. A wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, and other suitable radio access technologies beyond 5G (e.g., sixth generation (6G)).

A UE can communicate with a gNB or another UE to support extended Reality (XR) features. XR refers to all real-and-virtual combined environments and human-machine interactions generated by computer technology and wearables. XR is an umbrella term for different types of realities including Virtual reality (VR), Augmented reality (AR), and Mixed reality (MR), and the areas interpolated between them. The levels of virtuality range from partially sensory inputs to fully immersive VR. A key aspect of XR is the extension of human experiences, especially those relating to the senses of existence (represented by VR), and the acquisition of cognition (represented by AR). To be effective, various types of multimedia content for XR should be synchronized and communicated in some form of real time communication.

### SUMMARY

Various aspects of the present disclosure relate to devices and methods for wireless communication that support real-time communication data for multiple types of non-audiovisual content in addition to audiovisual media content exchanged with payload communication devices. A payload communication device can be one or both of a payload transmitting device and a payload receiving device that interfaces with other payload receiving/transmitting devices via a communication link with a respective user equipment. A payload transmitting device includes a controller having a processor that executes at least one user interface application that generates real-time communication data. The controller determines subprotocol format(s) of a real-time protocol that corresponds respectively to at least one of audiovisual media content and non-audiovisual content of the real-time communication data for communicating to the payload communicating device functioning as a payload receiving device. The controller establishes, via a transceiver, a communication link for a real-time data exchange session with a payload receiving device. The controller encapsulates the real-time communication data into real-time payload, using the subprotocol format(s). The controller transmits, via the transceiver, the real-time payload to the payload receiving device.

Some implementations of the method and apparatuses described herein may include a method for wireless communication at a user device. In one or more embodiments, the method may further include establishing, via a transceiver of the user device, a communication link for a real-time data exchange session with a payload communicating device functioning as a payload transmitting device. The method may further include receiving at least one subprotocol format of a real-time protocol that corresponds respectively to at least one of audiovisual media content and non-audiovisual content. The method includes receiving, via the transceiver, real-time payload from the payload transmitting device. The method may further include de-encapsulating the real-time communication data from the real-time payload, using the at least one subprotocol format. The method may further include executing at least one user interface application by a controller of the user device. The at least one user interface application utilizes the real-time communication data, including the at least one of the audiovisual media content and the non-audiovisual content.

Some implementations of the method and apparatuses described herein may include a method for wireless communication at a network device. In one or more embodiments, during establishment of a real-time data exchange session between a payload transmitting device and a payload receiving device, the method includes receiving a request, via a transceiver of the network device, from one of the payload transmitting device and the payload receiving device. The request is for a respective uniform resource identifier (URI) for at least one real-time subprotocol format for at least one of audiovisual media content and non-audiovisual content. The method may further include accessing, using the URI, the at least one real-time subprotocol format in a repository stored in memory of the network device. The repository contains a plurality of URIs, whereby each URI corresponds to a resource description of a subprotocol format. The method may further include transmitting the at least one real-time subprotocol format to at least one of the payload transmitting device and the payload receiving device. The at least one real-time subprotocol format includes a respective resource description that enables encapsulating and de-encapsulating real-time payload.

### BRIEF DESCRIPTION OF THE DRAWINGS

FIG. 1 is an example of a wireless communications system that supports real-time wireless communication between user devices, including payload communication devices interfacing with respective user equipments, in accordance with aspects of the present disclosure.

FIG. 2 is an overview diagram of real-time protocol (RTP) and real-time control protocol (RTCP) stack transmitted over Internet Protocol (IP) networks, in accordance with aspects of the present disclosure.

FIG. 3 is a diagram of web real-time communication (WebRTC) protocol stack over IP networks, in accordance with aspects of the present disclosure.

FIG. 4 is a diagram of RTP/SRTP packet formats and header information, in accordance with aspects of the present disclosure.

FIG. 5 illustrates an example RTP/SRTP header extension format and syntax, in accordance with aspects of the present disclosure.

FIG. 6 is an example generic payload of a real-time user data profile for RTP payload format, in accordance with aspects of the present disclosure.

FIG. 7 is an example RTP PDU containing a generic real-time user data payload type of an OpenXR_EXT_palm_pose subprotocol format payload, in accordance with aspects of the present disclosure.

FIG. 8 is an example RTP PDU containing a generic real-time user data payload type of an OpenXR_EXT_hand_tracking subprotocol format payload pertaining to user hand gesture tracking, in accordance with aspects of the present disclosure.

FIG. 9 is an example listing of data structures corresponding to sampled data of individual joints of the OpenXR extension for hand tracking, in accordance with aspects of the present disclosure.

FIG. 10 is a call flow diagram for real-time wireless communication using subprotocol formats for audiovisual media content and non-audiovisual content, in accordance with aspects of the present disclosure.

FIG. 11 illustrates a block diagram of a user device that performs payload transmission and/or payload reception of real-time communication data that includes at least one of audiovisual media content and non-audiovisual content, in accordance with aspects of the present disclosure.

FIG. 12 illustrates a block diagram of a network device that provides subprotocol format descriptions to the user devices to support establishment of real-time wireless communication data exchange of at least one of audiovisual media content and non-audiovisual content, in accordance with aspects of the present disclosure.

FIG. 13 illustrates a flowchart of a method performed by a user device for performing payload transmission of real-time wireless communication data including at least one of audiovisual media content and non-audiovisual content, in accordance with aspects of the present disclosure.

FIG. 14 illustrates a flowchart of a method performed by a user device for performing payload reception of real-time wireless communication data including at least one of audiovisual media content and non-audiovisual content, in accordance with aspects of the present disclosure.

FIG. 15 illustrates a flowchart of a method performed by a network device for providing subprotocol format descriptions to the user devices to support establishment of real-time wireless communication data exchange, in accordance with aspects of the present disclosure.

### DETAILED DESCRIPTION

Interactive communications imply various information flows carrying potentially time-sensitive inputs from an originating terminal to be transported over a network to a remote receiving terminal. Interactive applications relying on such multimedia modes of communication become more and more popular with expansion of massive online games, cloud gaming, and extended Reality (XR) applications. The multimedia information flows often go beyond traditional audio and video. Examples of additional format categories of real-time information flows include device capabilities, media description, and spatial interaction information. The flows are communicated over heterogeneous networks to or from graphic rendering engines and user devices. The audiovisual media types and additional real-time data types are thus fundamental to the successful implementation of truly immersive and interactive applications that process user input information and return reactions to the exciting user inputs under a set of delay constraints. The format and syntax of such information flows is often application, platform and/or hardware dependent. The customization of the information flows is in contradiction to well-established and standardized media formats and codecs (e.g., audio or video codecs) used in both real-time and non-real-time contexts. Thus, there are no well-established mainstream encodings for spatial interaction-based information flows. Moreover, such information flows and associated data formats evolve rapidly and require fast adaptation to new versions at a higher rate than typical conventional media codecs (e.g., of audiovisual content) development cycles. This motivates the search for solutions for transporting such information flows over a network in a real time, flexible and encoding-/syntax-agnostic manner to provide application developers necessary modern tools for fast emerging and disruptive interactive applications.

This disclosure proposes a novel real-time protocol (RTP) payload type that is generic and can thus also support non-standardized, non-audiovisual content. In one or more embodiments, the novel concept relies on the combination of: (i) A generic RTP payload type architecture to be used by custom subprotocols that are not defined with Internet assigned numbers authority (IANA) and can flexibly change from application to application, or equivalently, from software development kit (SDK) to SDK, e.g., XR interaction data that requires real-time transport; (ii) An extension of SDP to include signaling mechanisms necessary to support the generic RTP payload type and subprotocol formats; and (iii) A media description server storing and providing subprotocol information upon session description protocol (SDP) session establishment to the RTP peers.

According to aspects of the present disclosure, a method that is performed at a wirelessly networked device is provided. In one or more embodiments, the method may include determining, for a real-time multimedia data exchange session with a remote device, a uniform resource identifier (URI) of a subprotocol format, whereby the subprotocol format corresponds to an application-specified multimedia data type representation. The method may include accessing the URI hosted by a media description server, where the media description server further stores, at the URI, a resource description of the subprotocol format. The method may include applying the resource description of the subprotocol format to packetize the application-specified multimedia data type representation into a payload of a generic real-time payload type as part of one or more real-time transport Protocol Data Units (PDUs). The generic real-time payload type generically encapsulates any subprotocol format. The method may include establishing the real-time multimedia data exchange session with the remote device, based in part on the generic real-time payload type. The method may include performing one or more transmission-reception operations to transport, over a network, the one or more real-time transport PDUs comprising the subprotocol format as generic real-time payload type. A transmission-reception operation includes at least one of a transmission to the remote device and a reception from the remote device of the multimedia data type.

In one or more embodiments, the subprotocol format includes a non-audio-visual coded media data representation of the application-specified multimedia data type representation. In one or more embodiments, mapping for real-time multimedia data exchange session of the subprotocol format to the generic real-time payload type as a real-time PDU payload is performed in part based on SDP offer/answer procedure and associated SDP messages. The mapping is signaled in part based on a URI parameter of the generic real-time PDU payload type comprising the URI corresponding to the subprotocol format. In one or more particular embodiments, the SDP messages further include optional format parameters of the generic real-time payload type corresponding in part to at least one of: (i) a subprotocol identifier parameter comprising a value mapping to the generic real-time payload type; (ii) a clock rate parameter associated with the real-time protocol timestamping procedure comprising the number of clock ticks for a one second duration for a multimedia source producing data according to the subprotocol format; and (iii) one or more parameters common to the subprotocol format.

In one or more embodiments, the payload of the generic real-time payload type packetized as the real-time PDU payload includes at least one of: (i) a subprotocol identifier field; (ii) a subprotocol attributes field; and (iii) a subprotocol payload data field. In one or more embodiments, the media description server includes/hosts a repository containing a plurality of URIs corresponding to a plurality of resource descriptions of subprotocol formats. In one or more particular embodiments, the application-specified multimedia data type representation is an interaction data type and further includes at least one of: (i) a user pose description data type (e.g., as an encoding of azimuth, elevation, tilt, and associated ranges of motion describing the projection of the user view to a target display); (ii) a user field of view (FoV) data type (e.g., as the extent of the visible world from the user perspective usually described in angular domain, e.g., radians/degrees, over vertical and horizontal planes); (iii) a user pose or orientation tracking data type (e.g., as a timestamped 3D vector for position and quaternion representation for orientation describing up to six degrees of freedom (6DoF)); (iv) a user gesture tracking data type (e.g., as an array of hand joints tracked, each consisting of an array of hand joint locations relative to a base space location); (v) a user body tracking data type (e.g., as an encoding of the body and body segments primitives dynamic displacements); (vi) a user facial expression tracking data type (e.g., as an array of feature points positions mapped onto the face of the user, or as an encoding of predetermined facial expressions classes); (vii) a user eye movement tracking data type (e.g., as an array of key points positions mapped onto the eye anatomy, including at least one of cornea, pupil, iris, lacrimal caruncle, eyelids, and eyelashes); and (viii) an application augmented reality anchor data type (i.e., an AR metadata description determining the position of an object or a point in the user space as an anchor for placing virtual 2D/3D objects, such as text renderings, 2D/3D photo/video content).

In one or more embodiments, the resource description of the subprotocol format includes part of at least one of a version number of the subprotocol format, an Interface Description Language (IDL) schema of the subprotocol format, a list of SDP format parameters common to the subprotocol format, and a list of authoring metadata of the subprotocol format (e.g., last release date, author details, contact email, cryptographically signed manifest to verify all the contents of the resource description, etc.).

According to aspects of the present disclosure, an apparatus (e.g., user device) for wireless communications includes a processor and a memory that stores an application and is communicatively coupled with the processor. The processor executes the application to configure the apparatus to determine, for a real-time multimedia data exchange session with a remote device, a uniform resource identifier (URI) of a subprotocol format. The subprotocol format corresponds to an application-specified multimedia data type representation. The processor accesses the URI hosted by a media description server which stores, at the URI, a resource description of the subprotocol format. The processor applies the resource description of the subprotocol format to packetize the application-specified multimedia data type representation into a payload of a generic real-time payload type, as part of one or more real-time transport Protocol Data Units (PDUs). The generic real-time payload type generically encapsulates any subprotocol format. The processor establishes the real-time multimedia data exchange session with the remote device, based in part on the generic real-time payload type. The processor performs one or more transmission-reception operations to transport, over a network, the one or more real-time transport PDUs, including the subprotocol format as generic real-time payload type. A transmission-reception operation includes at least one of a transmission to the remote device and a reception from the remote device of the multimedia data type. In one or more embodiments, the apparatus performs the functionality of the methods described herein.

According to another aspect of the present disclosure, an apparatus having a memory coupled with a processor is provided for wireless communications. The processor is configured to cause the apparatus to store a repository containing a plurality of URIs. Each URI corresponds to a resource description of a subprotocol format. The subprotocol format is mappable to a payload of a generic real-time payload type as part of one or more real-time transport PDUs. The repository is hosted at an accessible network location. One or more requests are received from one or more remote devices accessing the accessible network location to download one or more URIs of the repository. For each of the requests from the one or more remote devices, the available one or more URIs within the repository are determined and transferred to the corresponding remote device.

The present disclosure proposes a mechanism to support a generic payload format over RTP, whereby only one payload format needs to be registered with IANA and described within Internet Engineering Task Force (IETF) Requests For Comment (RFCs). The disclosure solution uses the generic payload to dynamically instantiate its format, or equivalently syntax, based on a central repository of available multimedia data types and associated syntaxes. To this end, the disclosure uses the SDP mechanism and an RTP media description server to dynamically provide the syntax information of an RTP media type during the establishment of the RTP session. This process enables using the RTP as a payload agnostic, time-synchronized, real-time capable transport medium for various types of data with strict synchronization requirements, such as media description and interaction data classes previously detailed, over a network.

This disclosure benefits networked applications and application developers in using the RTP protocol stack in a simpler way to transport and synchronize any data types of potentially uncoded sources beyond the established coded audio (e.g., MP4, OPUS, E-AC3, AC3, etc.), visual (e.g., H.263, H.264, H.265, AV1, VP8, VP9 etc.), textual (e.g., 3rd generation partnership project (3GPP)-TimedText,) formats, and the formats that rely on FEC (e.g., ulpfec, raptorfec, parityfec) for multimedia content delivery. To one trained in the art, the mechanisms and embodiments described herein apply equally to the secure counterpart of RTP, i.e., SRTP. To this end, by reference of RTP, extensions of SRTP usage and embodiments are considered derivatives of the disclosed methods, protocols, and apparatuses.

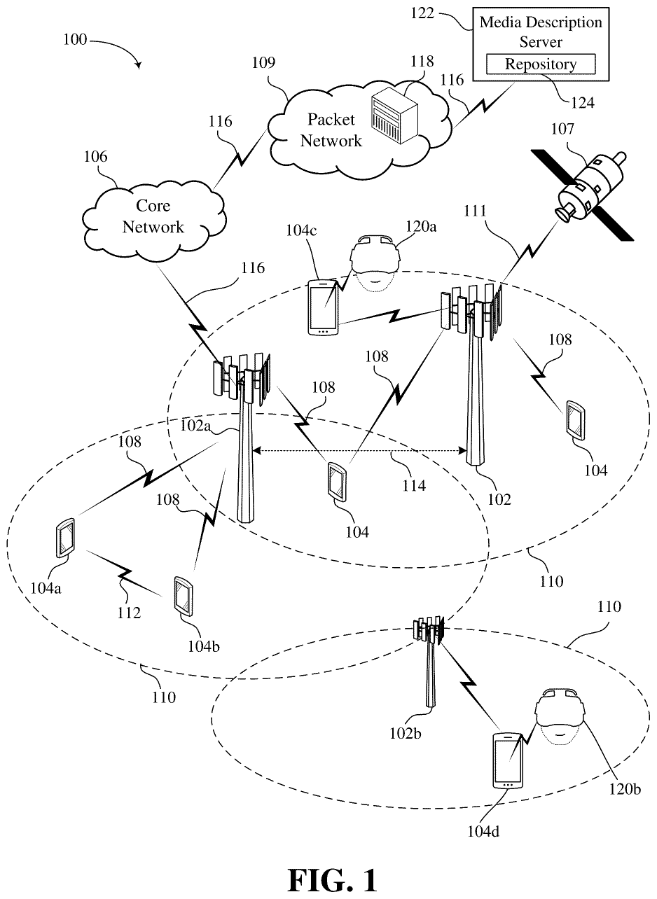

FIG. 1 illustrates an example of a wireless communications system 100 enabling and supporting real-time wireless communication between user devices, in accordance with aspects of the present disclosure. The wireless communications system 100 may include one or more network devices 102, one or more UEs 104, a core network 106, and a packet data network 109. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as a New Radio (NR) network. In other implementations, the wireless communications system 100 may be a combination of a 4G network and a 5G network. The wireless communications system 100 may support radio access technologies beyond 5G, or other suitable radio access technology including Institute of Electrical and Electronics Engineers (IEEE) 802.11 (Wi-Fi), IEEE 802.16 (WiMAX), IEEE 802.20. Additionally, the wireless communications system 100 may support technologies, such as time division multiple access (TDMA), frequency division multiple access (FDMA), or code division multiple access (CDMA), etc.

The one or more network devices 102 may be dispersed throughout a geographic region to form the wireless communications system 100. One or more of the network devices 102 described herein may be, may include, or may be referred to as a network node, a base station, a network element, a radio access network (RAN), a base transceiver station, an access point, a NodeB, an eNodeB (eNB), a next-generation NodeB (gNB), a network device, or other suitable terminology. A network device 102 and a UE 104 may communicate via a communication link 108, which may be a wireless or wired connection. For example, a network device 102 and a UE 104 may wirelessly communicate (e.g., receive signaling, transmit signaling) over a user to user (Uu) interface.

A network device 102 may provide a geographic coverage area 110 for which the network device 102 may support services (e.g., voice, video, packet data, messaging, broadcast, etc.) for one or more UEs 104 within the geographic coverage area 110. For example, a network device 102 and a UE 104 may support wireless communication of signals related to services (e.g., voice, video, packet data, messaging, broadcast, etc.) according to one or multiple radio access technologies. In some implementations, a network device 102 may be moveable, for example, a satellite 107 associated with a non-terrestrial network and communicating via a satellite link 111. In some implementations, different geographic coverage areas 110 associated with the same or different radio access technologies may overlap, but the different geographic coverage areas 110 may be associated with different network devices 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network devices 102, other UEs 104, or network equipment (e.g., the core network 106, the packet data network 109, a relay device, an integrated access and backhaul (IAB) node, or another network equipment), as shown in FIG. 1. Additionally, or alternatively, a UE 104 may support communication with other network devices 102 or UEs 104, which may act as relays in the wireless communications system 100.

A UE 104a may also be able to support wireless communication directly with other UEs 104b over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104a may support wireless communication directly with another UE 104b over a PC5 interface. PC5 refers to a reference point where the UE 104a directly communicates with another UE 104b over a direct channel without requiring communication with the network device 102a.

A network device 102 may support communications with the core network 106, or with another network device 102, or both. For example, a network device 102 may interface with the core network 106 through one or more backhaul links 114 (e.g., via an S1, N2, or another network interface). The network devices 102 may communicate with each other over the backhaul links 114 (e.g., via an X2, Xn, or another network interface). In some implementations, the network devices 102 may communicate with each other directly (e.g., between the network devices 102). In some other implementations, the network devices 102 may communicate with each other indirectly (e.g., via the core network 106). In some implementations, one or more network devices 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission and reception points (TRPs).

In some implementations, a network entity or network device 102 may be configured in a disaggregated architecture, which may be configured to utilize a protocol stack physically or logically distributed among two or more network entities or network devices 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity or network device 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission and reception point (TRP). One or more components of the network entities or network devices 102 in a disaggregated RAN architecture may be co-located, or one or more components of the network entities or network devices 102 may be located in distributed locations (e.g., separate physical locations). In some implementations, one or more network entities or network devices 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities or network devices 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more network devices 102 associated with the core network 106.

The core network 106 may communicate with the packet data network 109 over one or more backhaul links 116 (e.g., via an S1, N2, N2, or another network interface). The packet data network 109 may include an application server 118. In some implementations, one or more UEs 104 may communicate with the application server 118. A UE 104 may establish a session (e.g., a protocol data unit (PDU) session, or the like) with the core network 106 via a network entity or network device 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

According to aspects of the present disclosure, the wireless communication system 100 may support a real-time data communication session between a first user device 120a and a second user device 120b. First user device 120a and a second user device 120b can be generally referred to as payload communication devices. A payload communication device can be one or both of a payload transmitting device and a payload receiving device that interfaces with other payload receiving/transmitting devices via a communication link with a respective user equipment. In an example, first user device 120a, such as a head mounted display (HMD), is tethered to UE 104c for wireless communication with network device 102 using a real-time protocol (RTP). Second user device 102a may also be an HMD tethered to UE 104d for wireless communication with network device 102b using RTP. In order to support real-time communication of one or more different data types synchronized for presentation at second user device 120b, first user device 120a uses format subprotocols for each different data type. Similarly, in order to support real-time communication of the one or more different data types synchronized for presentation at first user device 120b, second user device 120a uses format subprotocols for each different data type. While first user device 120a and second user device 120b are described as a payload transmitting device and a payload receiving device providing single direction communication, it is appreciated that the two user devices (120a, 120b) can be similarly configured to provide both the receiving and transmitting functionality to enable bi-directional communication. To enable customization of support for the different real-time communication data of different data types, the packet data network 109 may include a media description server 122 that supports a number of RTP subprotocols for RTP. In particular, media description server 122 includes a repository 124 of RTP subprotocol format descriptions accessible by the first and the second user devices 120a-120b acting respectively as RTP packet transmitting and receiving devices. The wireless communication system 100 facilitates establishment of an RTP communication session between the first and the second user devices 120a-120b. The RTP communication session may be a secure RTP communication session.

In the wireless communications system 100, the network entities or network devices 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities or network devices 102 and the UEs 104 may support different resource structures. For example, the network entities or network devices 102 and the UEs 104 may support different frame structures. In some implementations, such as in 4G, the network entities or network devices 102 and the UEs 104 may support a single frame structure. In some other implementations, such as in 5G and among other suitable radio access technologies, the network entities or network devices or network devices 102 and the UEs 104 may support various frame structures (i.e., multiple frame structures). The network entities or network devices 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the network entities or network devices 102 and the UEs 104 may perform wireless communications over one or more of the operating frequency bands. In some implementations, FR1 may be used by the network entities or network devices 102 and the UEs 104, among other equipment or devices for cellular communications traffic (e.g., control information, data). In some implementations, FR2 may be used by the network entities or network devices 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Interactive extended Reality (XR) is used as an umbrella term for different types of realities such as virtual reality (VR), augmented reality (AR) and mixed reality (MR). VR is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary. AR includes overlaying a current visual environment with additional information or content. The additional information or content will usually be visual and/or audible and their observation of their current environment may be direct, with no intermediate sensing, processing, and rendering, or indirect, where their perception of their environment is relayed via sensors and may be enhanced or processed. MR is an advanced form of AR where some virtual elements are inserted into the physical scene with the intent of providing the illusion that these elements are part of the real scene. XR refers to all real-and-virtual combined environments and human-machine interactions generated by computer technology and wearables. XR includes representative forms such as AR, MR and VR and the areas interpolated across them. The levels of virtuality range from partially sensory inputs to fully immersive VR. A key aspect of XR is the extension of human experiences, especially relating to the senses of existence (represented by VR), and the acquisition of cognition (represented by AR).

Central to the success of an immersive XR experience are the interaction and spatial computing associated with an XR application activity. This applies similarly to other mainstream interaction-driven applications, such as Cloud Gaming (CG). The interaction data and associated spatial computing that determines the XR rendering engine or CG gaming engine responses to the user physical inputs thus contribute to cyber-physical illusion of immersiveness between the physical and virtual worlds.

The data that such applications carry and leverage to generate the cyber-physical immersiveness illusion is categorized in device capability class, media description class, and interaction class. The formats associated with device capability class describes the physical and hardware capabilities of an end user equipment (UE) and/or glass device. Some examples in this sense are camera sub-system capabilities and camera configuration (e.g., focal length, available zoom, and depth calibration information, pose reference of the main camera, etc.) and projection formats (e.g., cubemap, equirectangular, fisheye, stereographic etc.). The device capability data is usually static and available before the establishment of a session, hence its transfer and transport of a network is not of high concern as the device capability data can be embedded in typical session configuration procedures and protocols, such as Session Initiation Protocol (SIP) and/or Session Description Protocol (SDP). The device capability data is as such not real-time sensitive and has no real-time transport requirements.

Media description class type describes the space and/or the object content of a view. For instance, this data can be a scene description used to detail the 3D composition of space anchoring 2D and 3D objects within a scene (e.g., as a tree or graph structure usually of glTF2.0 or JSON syntax). Another possible representation is of a spatial description used for spatial computing and mapping of the real-world to its virtual counterpart or vice versa. In some other examples, this data type may contain 3D model descriptors of objects and their attributes formatted for instance as meshes (i.e., sets of vertices, edges and faces), or point cloud data formatted under POLYgon (PLY) syntax to be consumed by the visual presentation devices, i.e., the UEs. Other data types may represent dynamic world graph representations whereby selected trackables (e.g., geo-cached AR/QR codes, geo-trackables like physical objects located at a specified world position, dynamic physical objects like buses, subways, etc.) enter and leave the scene perspective of the world dynamically and need to be conveyed in real-time to an AR runtime. The media description class of data may be of large size (i.e., often even more than 10 MBytes) and it may be updated with low frequency (within 10 s of seconds regime) under various event triggers (e.g., user viewport change, new object entering the scene, old object exiting the scene, scene change and/or update etc.). The media description data may be real-time sensitive, as being involved in completing the display of the virtual renderings to a presentation device such as a UE, and as a result may benefit from real-time transport over a network.

Interaction class type contains user spatial interaction information such as:
(i) user viewport description (i.e., an encoding of azimuth, elevation, tilt, and associated ranges of motion describing the projection of the user view to a target display);
(ii) user field of view (FoV) (i.e., the extent of the visible world from the viewer perspective usually described in angular domain, e.g., radians/degrees, over vertical and horizontal planes);
(iii) user pose/orientation tracking data (i.e., micro-/nanosecond timestamped 3D vector for position and quaternion representation for orientation describing up to six (6) degrees of freedom (DoF);
(iv) user gesture tracking data (i.e., an array of hands gestures tracked, each consisting of an array of hand joint locations relative to a base space);
(v) user body tracking data (e.g., a Bio Vision Hierarchical BVH encoding of the body and body segments movements);
(vi) user facial expression/eye movement tracking data (e.g., as an array of key points/features positions or their encoding to pre-determined facial expression classes); and
(vii) application and AR anchor data and description (i.e., metadata determining the position of an object or a point in the user space as an anchor for placing virtual 2D/3D objects, such as text renderings, 2D/3D photo/video content etc.).

The interaction class data has the following characteristics:
(i) low data footprint of usually up to about hundreds of Bytes per message;
(ii) high sampling rates within the 250 Hz-1000 Hz range;
(iii) data that can trigger a response with low-latency requirements (e.g., up to 1 second end-to-end from the interaction to the response as perceived by the user);
(iv) can be synchronized to other media streams (e.g., video or audio media stream);
(v) can be synchronized to other interaction data;
(vi) optional reliability, as determined by individual application requirements;
(vii) data encoding follows usually proprietary/non-standardized or rapidly evolving application formats and interaction dependent formats; and
(vii) carries privacy sensitive interaction events and data.

The interaction data is therefore real-time sensitive and requires real-time transport over a network. Currently, with conventional solutions, the media description and interaction data benefitting real-time transmission and synchronization are, in some implementations, transmitted over WebRTC data channels or other similar non-time-critical network stacks protocol stacks. For instance, the WebRTC data channels do not cater for time-sensitive transport means relying on the Stream Control Transmission Protocol (SCTP), and as such, real-time transport solutions are desirable.

The present disclosure recognizes and responds to a need for solutions catering for diverse multimedia data types (e.g., media description, interaction data classes and their subcategories), including various syntax and formats, various data sizes (e.g., from hundreds of Bytes to tens of MBytes), various timed data generation (e.g., from periodically generated with strict timing to event-based data), and real-time synchronization constraints.

Real-time protocol (RTP) and web real-time communication (WebRTC) transport presents real-time suited transport architectures and protocols that are mainly state of art on the RTP, its securely provisioned Secure Real-time Transport Protocol (SRTP), and its web-targeted stack Web Real-Time Communications WebRTC, respectively. RTP is a media codec agnostic network protocol with application-layer framing used to deliver multimedia (e.g., audio, video etc.) data in real-time over IP networks. RTP is used in conjunction with a sister protocol for control, i.e., Real-time Transport Control Protocol (RTCP), to provide end-to-end features such as jitter compensation, packet loss and out-of-order delivery detection, synchronization and source streams multiplexing.

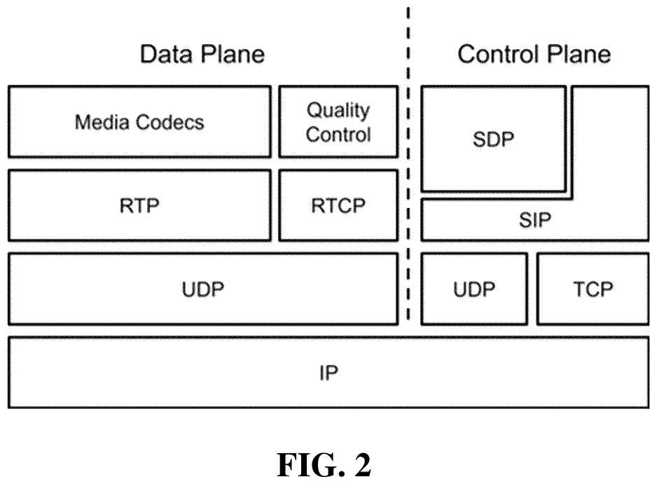

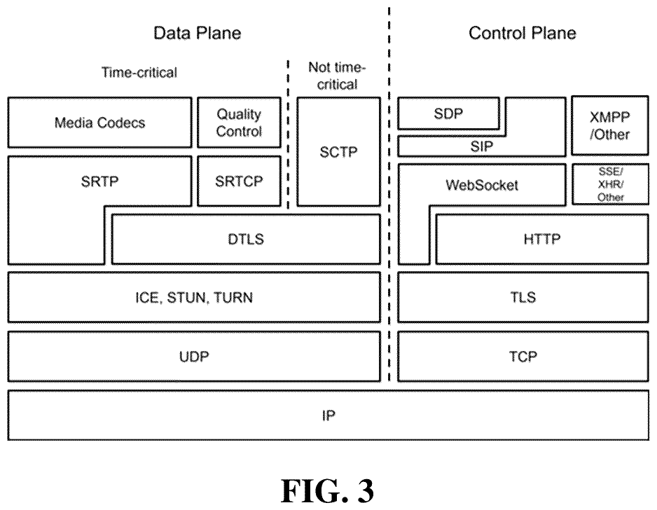

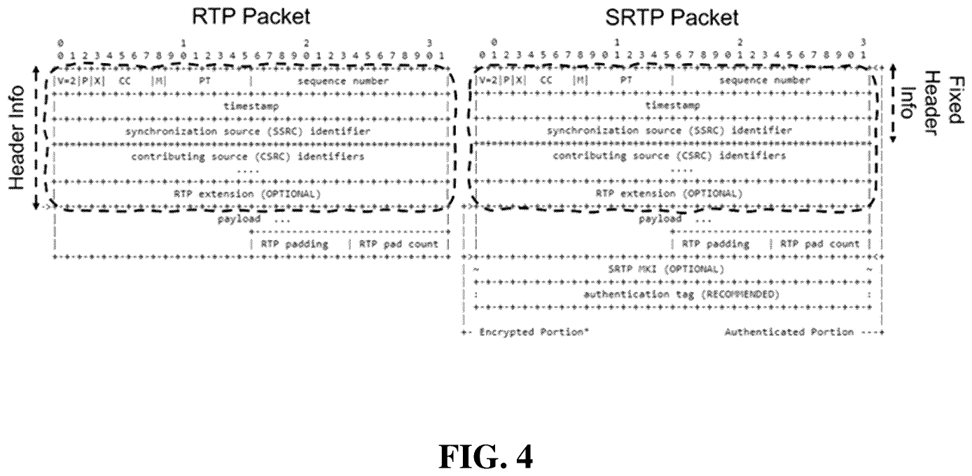

FIG. 2 is an overview diagram of the RTP and RTCP stack transmitted over Internet Protocol (IP) networks. FIG. 3 is a diagram of WebRTC protocol stack over IP networks. FIG. 4 is a diagram of RTP/SRTP packet formats and header information. Secure real-time protocol (SRTP) is a secured version of RTP, providing encryption (mainly by means of payload confidentiality), message authentication and integrity protection (by means of PDU, i.e., headers and payload, signing), as well as replay attack protection. Similar to RTP, the SRTP sister protocol is secure real-time control protocol (SRTCP). This provides the same functions to its RTCP counterpart. As such, in vanilla SRTP versions, the RTP header information is still accessible but non-modifiable, whereas the payload is encrypted. These security provisions are illustrated in part over the right-hand side of FIG. 4. Furthermore, the key exchange and additional security parameters necessary to use SRTP are based upon the Datagram Transport Layer Security (DTLS) key exchange procedure. SRTP is used for these reasons as the transport protocol for media in the WebRTC stack, which ensures secure RTC multimedia communications over web browser interfaces.

An overview of the WebRTC stack is provided in FIG. 3. As illustrated, an IP layer carries signaling from the data plane and the control plane. The data plane stack comprises functions for User Datagram Protocol (UDP), Interactive Connectivity Establishment (ICE), Datagram Transport Layer Security (DTLS), SRTP, SRTCP, media codecs, Quality Control and SCTP. ICE may use the Session Traversal Utilities for NAT (STUN) protocol and Traversal Using Relays around NAT (TURN) to address real-time media content delivery across heterogeneous networks and NAT rules and firewalls. The SCTP data plane is mainly dedicated as an application data channel and may be non-time critical, whereas the SRTP based stack including elements of control, i.e., SRTCP, encoding, i.e., media codecs, and Quality of Service (QoS), i.e., Quality Control, is dedicated to time-critical transport.

The individual fixed header information and complete header information (including header extensions) is briefly summarized for the RTP/SRTP packets as follows for fixed header information and complete head information including header extensions. Fixed header information includes:
(i) V—2 bits indicating the protocol version used;
(ii) P—1 bit field indicating that one or more zero-padded octets at the end of the payload are present, whereby, among others, the padding may be necessary for fixed-sized encrypted blocks or for carrying multiple RTP/SRTP packets over lower layer protocols;
(iii) X—1 bit indicating that the standard fixed RTP/SRTP header will be followed by an RTP header extension usually associated with a particular data/profile that will carry more information about the data (e.g., the frame marking RTP header extension for video data, or generic RTP header extensions such as the RTP/SRTP extended protocol);
(iv) CC—4 bits indicating number of contributing media sources (CSRC) that follow the fixed header;
(v) M—1 bit intended to mark an information frame boundaries in the packet stream, whose behavior is exactly specified by RTP profiles (e.g., H.264, H.265, H.266, AV1 etc.);
(vi) PT—7 bits indicating the payload type, which in case of audio and video codec profiles may be dynamic and negotiated by means of SDP (e.g., 96 for H.264, 97 for H.265, 98 for AV1 etc.). The payload profiles are registered with IANA and rely on IETF profiles describing how the transmission of data is enclosed within the payload of an RTP PDU. Current IANA registered payload profiles describe audio/video codecs and application-based forward-error correction (FEC) coded media content, yet none cater for uncoded non audiovisual data formats;
(vii) Sequence number—16 bits indicating the sequence number which increments by one with each RTP data packet sent over a session;
(viii) Timestamp—32 bits indicating timestamp in ticks of the payload type clock reflecting the sampling instant of the first octet of the RTP data packet (associated for video stream with a video frame), whereas the first timestamp of the first RTP packet is selected at random;
(ix) Synchronization Source (SSRC) identifier—32 bits field indicating a random identifier for the source of a stream of RTP packets forming a part of the same timing and sequence number space, such that a receiver may group packets based on synchronization source for playback; and
(x) Contributing Source (CSRC) identifier—list of up to 16 CSRC items of 32 bits each given the amount of CSRC mixed by RTP mixers within the current payload as signaled by the CC bits. The list identifies the contributing sources for the payload contained in this packet given the SSRC identifiers of the contributing sources.

Complete header information, including header extensions, include RTP header extension. RTP header extension is a variable length field present if the X bit is marked. The RTP header extension is appended to the RTP fixed header information after the CSRC list. If present, the RTP header extension is 32-bit aligned and formed of the following fields: (i) 16-bit extension identifier defined by a profile and usually negotiated and determined via the Session Description Protocol (SDP) signaling mechanism; (ii) A 16-bit length field describing the extension header length in 32-bits multiples excluding the first 32 bits corresponding to the 16 bits extension identifier and the 16 bits length fields itself; and (iii) A 32-bit aligned header extension raw data field formatted according to some RTP header extension identifier specified format.

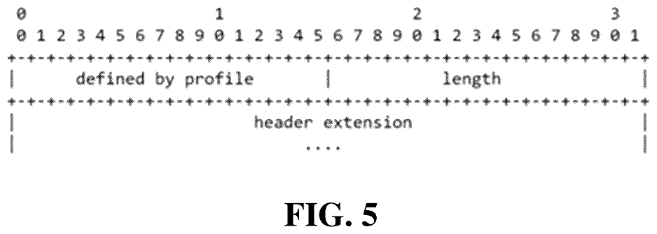

FIG. 5 is RTP/SRTP header extension format and syntax. The RTP header extension format and syntax are like the ones of SRTP. In addition, in both RTP and SRTP, only one RTP extension header may be appended to the fixed header information. However, for both RTP and SRTP, extensions to the base protocols exist to allow for multiple RTP header extensions of predetermined types to be appended to the fixed header information of the protocols. In some embodiments, RTP header extensions produced at the source may be ignored by the destination endpoints that do not have the knowledge to interpret and process the RTP header extensions transmitted by the source endpoint.

The present disclosure proposes a mechanism to support a generic payload format over RTP, whereby only one payload format needs to be registered with IANA and described within IETF RFCs. The disclosure solution uses the generic payload to dynamically instantiate its format, or equivalently syntax, based on a central repository of available multimedia data types and associated syntaxes. To this end, the disclosure uses the SDP mechanism and an RTP media description server to dynamically provide the syntax information of an RTP media type during the establishment of the RTP session. This process enables using the RTP as a payload agnostic, time-synchronized, real-time capable transport medium for various types of data with strict synchronization requirements, such as media description and interaction data classes previously detailed, over a network.

This disclosure benefits networked applications and application developers in using the RTP protocol stack in a simpler way to transport and synchronize any data types of potentially uncoded sources beyond the established coded audio (e.g., MP4, OPUS, E-AC3, AC3, etc.), visual (e.g., H.263, H.264, H.265, AV1, VP8, VP9 etc.), textual (e.g., 3rd generation partnership project (3GPP)-TimedText,) formats, and the formats that rely on FEC (e.g., ulpfec, raptorfec, parityfec) for multimedia content delivery. To one trained in the art, the mechanisms and embodiments described herein apply equally to the secure counterpart of RTP, i.e., SRTP. To this end, by reference of RTP, extensions of SRTP usage and embodiments are considered derivatives of the disclosed methods, protocols, and apparatuses.

A first embodiment of the present disclosure provides generic RTP payload format with dynamic syntax signaling. The format of the RTP payload is determined by the payload type (PT) field. The code within the payload type field indicates and identifies the RTP payload syntax and semantics. The payload type field code may, in one embodiment, contain a statically determined value based on a pre-defined table containing media profile and associated RTP payload type profiles. In another embodiment, the RTP payload type may be determined and signaled dynamically through the SDP offer/answer procedure in which a sender and receiver agree upon a payload type code and media profile describing the syntax and semantics of the payload. The dynamic signaling of the payload type field value is the default preferred option for RTP embodiments.

To support a generic RTP payload format, a generic profile of user data is needed. To this end, the first embodiment may include use of an IANA-registered media profile of generic real-time user data. In one example of a 3GPP profile registration, the profile may be named “3gpp-rt-userdata”, which represents real-time user data profile. Similarly, in another example of a non-3PPP specific profile registration, the profile may be named “rt-userdata”.

In a first example, the real-time user data profile will serve RTP media flows of type application. The payloads of such RTP media flows may consist of binary encoded controller inputs and commands to a CG engine, such as for instance OpenXR specific controller extensions (OpenXR_EXT_*) or alike. In other examples, this data type may comprise of real-time and synchronized recordings of sensor subsystems from a device, like a XR UE.

In a second example, the real-time user data profile will serve RTP media flows of type “audio”. In some examples, this profile may include audio mixer, equalizer and mapper settings or configurations that are necessary for a remote audio renderer to generate immersive sounds according to either the dynamics of a video/game scene or the dynamics of a user.

In a third example, the real-time user data profile will serve RTP media flows of type “video”. In some examples, this profile may comprise scene graphs detailing the graphic or object contents of a video scene. In other examples, this profile may include 3D video objects in either mesh or point cloud encodings and their position placement within an existing scene.

In a fourth example, the real-time user data profile will serve RTP media flows of type “text”. In some examples, this profile may comprise of text encoded application information (e.g., JavaScript Object Notation), such as user input commands, multi-language captions, sensor readings, 3D anchors and their description, etc.

The generic real-time user data profile may contain, in some embodiments, a pre-determined, default clock rate indicating the sampling time, i.e., the number of ticks corresponding to a sampling time of 1 second, at the source of the user data. For example, 1000 indicates that a 1000 samples per second is used at a source/sensor as the clock rate for timestamping the first octet of the RTP payload. In other embodiments, a dynamically determined clock rate is used to indicate the sampling time of the source data. In such embodiments, the SDP media flow is used to indicate in an offer/answer procedure the clock rate associated with the source data. The clock rate will be used by the RTP timestamp for time synchronization of various sources as well as jitter compensation.

In some embodiments, the user data may be event triggered and thus non-periodic. In these embodiments, instead of indicating the source sampling frequency, the clock rate is just set dynamically (over SDP) to aid with the synchronization and jitter compensation of associated user data. In such embodiments, the resolution of the clock rate shall be selected to match a desired resolution of synchronization between events-triggered media flows and other media flows that are generated or utilized by the RTP served application. In an example, an RTP application may set a clock-rate of 1000 that provides up to 1 ms resolution to synchronize a user interaction data flow (e.g., hand waving gesture) with a video media flow.

Example listings of SDP offer/answer of media flows of real-time user data include:

$$( i ) m = application 58126 RTP / AVP 200 ;$$

$$( ii ) a = rtpmap : 200 rt - userdata / 1000 ;$$

$$( iii ) m = audio 58127 RTP / AVP 201 ;$$

$$( iv ) a = rtpmap : 201 rt - userdata / 1000 ;$$

$$( v ) m = video 58128 RTP / AVP 202 ;$$

$$( vi ) a = rtpmap : 202 rt - useradata / 1000 ;$$

$$( vii ) m = text 58127 RTP / AVP 203 ; and$$

$$( vii ) a = rtpmap : 203 rt - userdata / 1000.$$

The above listing example illustrates the SDP signaling over an offer/answer SDP message establishing an RTP session where 4 media flows are available on different ports serving different types of real-time user data. Thus, transmitted on port 58126 is application real-time user data, e.g., video game controller input, video game engine monitoring data, etc. Transmitted on port 58127 is an audio real-time user data, e.g., an audio equalizer configuration, or alternatively, a dynamic audio mapping configuration of sound synthetization. Transmitted on port 58128 is a video real-time user data, e.g., a .png image overlay information for an AR application. Transmitted on port 58129 is a text real-time user data, e.g., a marked-up closed caption overlay containing enhanced live caption and emoji support for a conversational AR application. All media streams described in the above listing are configured to a 1000 clock-rate such that a 1 second sampling time is represented in the RTP timestamp by a clock tick delta of 1000.

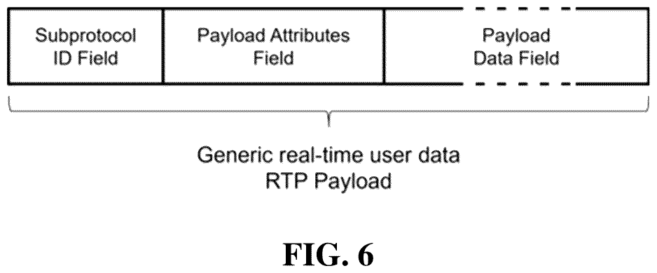

FIG. 6 is an example generic payload (i.e., a subprotocol profile) of a real-time user data profile for RTP payload format. This payload format consists of a subprotocol profile identifier field, a payload attributes field, and a payload.

In one embodiment, the subprotocol profile identifier field is used to differentiate between different formats and associated syntax and semantics of RTP payloads under the generic RTP real-time user data profile. The subprotocol profile identifier value therefore marks a protocol syntax and semantics uniquely under a namespace.

In an embodiment the subprotocol identifier value is determined dynamically by means of SDP offer/answer negotiation between a sender and receiver. The subprotocol identifier value is, in such an embodiment, mapped to a uniform resource identifier (URI) uniquely determining the format of the RTP payload within a given namespace. The access protocol to the remote URI subprotocol is up to an implementation and, in some embodiments, may be comprised of a webserver via http/https, an FTP server via ftp/sftp, a network attached storage and associated protocols, e.g., CIFS, SMB etc. In one example, the URI may be defined as ‘https://example.com/<namespace>/<subprotocol>’, or as ‘https://example.com/<namespace>/<subprotocol>/<subprotocol_version_major.minor.path>’. In such embodiments, the subprotocol version may be explicitly signaled within the URI, or alternatively, may be implicitly conveyed by rerouting rules applicable to accessing the URI and its underlying protocol, i.e., http/https, ftp, SMB/CIFS, etc.

In another embodiment, when the namespace is implicit, the subprotocol identifier value may be mapped to a uniform resource name (URN) as an URI subset. In such a case, the URN, as a logical subset of an URI, provides the identification mapping of the subprotocol identifier to a known protocol or profile as per definition of an Internet registry or authority. In one example, the URN may be defined according to IETF URN sub-namespace for registered protocol parameters (RFC 3553), such as ‘urn:ietf:params:3gpp-rt-userdata:<subprotocol>’, or similarly, as ‘urn:ietf:params:rt-userdata:<subprotocol>’. In such an example, the <subprotocol> parameter identifies an RFC protocol definition, such as for example a WebSocket subprotocol identifier of the IANA WebSocket Protocol Registries.

In some embodiments, the format parameters attribute of SDP is used to determine and map the subprotocol id to a generic real-time user data RTP media payload type. In an example, the RTP generic real-time user data media payload type 200 is mapped to an OpenXR_EXT_hand_tracking subprotocol with the subprotocol id 52, as with the below example.

$$…$$

$$m = application 58126 RTP / AVP 200$$

$$a = rtpmap : 200 rt - userdata / 1000$$

$$a = fmtp : 200 uri = https \text{://} example . com / media - descriptions / OpenXR\_EXT \_hand \_tracking . html \#idl subprotocol - id = 52$$

$$…$$

As such, in an embodiment, the URI is a mandatory parameter of the format type associated with the generic real-time user data payload type for RTP PDUs. In one embodiment, the subprotocol-id parameter of the format type associated with the generic real-time user data payload type for RTP PDUs is optional and, if specified in the SDP, takes precedence to other implicit instantiations, as for example, based in part on the processing of the resource determined by the URI.

In some embodiments, for some of the subprotocols used, the payload attributes are one-hot encoded subfields representing toggling of various attributes that will be present in the payload of a subprotocol. In an embodiment, these subfields may be in part reserved for future use by a subprotocol. In other embodiments, the subfields semantics may be fully specified by the subprotocol used within the generic real-time user data payload type. However, in other embodiments, the payload attributes may be skipped, i.e., no payload attributes field will be present in the generic real-time user data payload type.

In one example, a subprotocol of the generic real-time user data profile may specify a finer resolution timing beyond the RTP timestamp allowing for finer synchronization at the application level, e.g., up to nanoseconds precision, based on out-of-band client-server clock synchronization using the Precision Time Protocol (PTP). In this example, the payload attributes subfield may contain a one-bit synchronization field, i.e., ‘S’, that will be toggled when an additional timestamp attribute will be included in the payload. Alternatively, in an example catering for event triggered data that does not rely on very strict real-time constraints yet where the data is split among many payloads, the payload attributes may contain an attribute subfield indicating reliability, i.e., ‘R’. In this embodiment, the toggling of the reliability attribute bit may trigger application-driven retransmission of any dropped packets, based in part on the RTCP reports about acknowledged RTP packets. In a different example, several bits in the payload attributes field may be marked as ‘RESERVED’ for future used, whereas the number of bits reserved is chosen such that the total bit length of the payload attributes field is an integer number of words, i.e., returns 0 to modulo 4-bit operation.

In an embodiment, the payload data field contains data attributes and data. The payload format of the data attributes and data is determined by the subprotocol identifier and its mapping to the URI, or alternatively, to the URN specifying the formatting rules. In some embodiments, the payload data field contains only data, and in such embodiments the payload attributes field is not available within the syntax and semantics of a corresponding subprotocol identified by the subprotocol ID field.

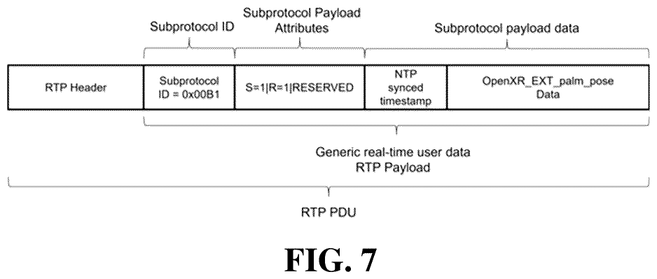

FIG. 7 is an example RTP PDU containing a generic real-time user data payload type of an OpenXR_EXT_palm_pose subprotocol format payload. In this example the following holds:
(i) the subprotocol identifier field spans a length of 16 bits, allowing for transmission of up to 216 different subprotocols over an RTP session, whereby the subprotocol identifier field is mapped to subprotocol ID=0x00B1 corresponding to the OpenXR_EXT_palm_pose signaled via SDP offer/answer procedure by an URI, which identifies an online resource where an application can attain the necessary syntax and semantics description for processing the generic real-time user data payload type associated with the dynamically mapped subprotocol ID=0x00B1.
(ii) the payload attributes field spans a length of 8 bits allowing for a maximum number of 8 attributes to be specified for any subprotocol, and whereby 2 bits correspond to: (a) a 1-bit synchronization toggle ‘S’ allowing subprotocols to define and provide their own additional timing synchronization data on top of the already existent RTP timestamp; (b) a 1-bit reliability toggle ‘R’ allowing subprotocols to support application-based retransmission mechanisms and procedures over the top of RTP; and (c) a remaining set of 6 bits which have ‘RESERVED’ status and may be used for some other attributes.
(iii) the payload data containing, in part, a synchronization attribute, e.g., as a 64 bits timestamp synchronized to UTC time according to NTP procedure, followed by the OpenXR_EXT_palm_pose data bytes.

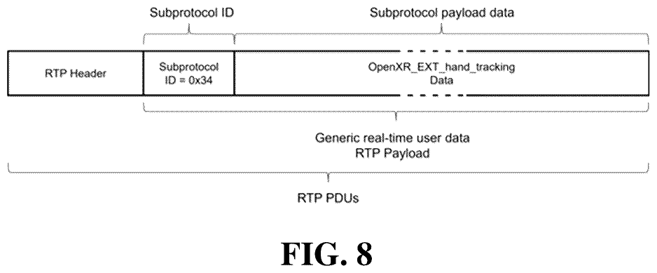

FIG. 8 is an example RTP PDU containing a generic real-time user data payload type of an OpenXR_EXT_hand_tracking subprotocol format payload pertaining to user hand gesture tracking. In this example the following fields are present:
(i) the subprotocol identified field spans a length of 8 bits, allowing for transmission of up to 256 different subprotocols over an RTP session, whereby the subprotocol identifier field is mapped to ID=0x34 corresponding to the OpenXR_EXT_hand_tracking signaled via SDP offer/answer procedure by an URI that identifies an online resource where an application can attain the necessary syntax and semantics description for processing the generic real-time user data payload type associated with the dynamically mapped subprotocol ID=0x34.
(ii) the payload data containing the OpenXR_EXT_hand_tracking embeds an application determined XrTime and XrSpace as base space for up to 26 joint locations for each of the two user hands resulting in a payload containing metadata information (e.g., space, time samples anchoring) and locations (3D locations and velocities) of up to 52 selected joint points as a list, or alternatively, an array of pose data samples.

In one example based on FIG. 8, the subprotocol payload data may be split across multiple RTP PDUs. For instance, in one instance, an application client operating on a fifth-generation system (5GS), or similar, UE and using the OpenXR_EXT_hand_tracking format may desire to transmit the content of tracking two hands, i.e., left and right hand objects, in real-time to a central XR server. In such a scenario, 26 joint tracking information need to be sent for each hand tracked object. This results in a total of 52 tracking points with additional metadata indicating their mapping to a left or right hand tracked object.

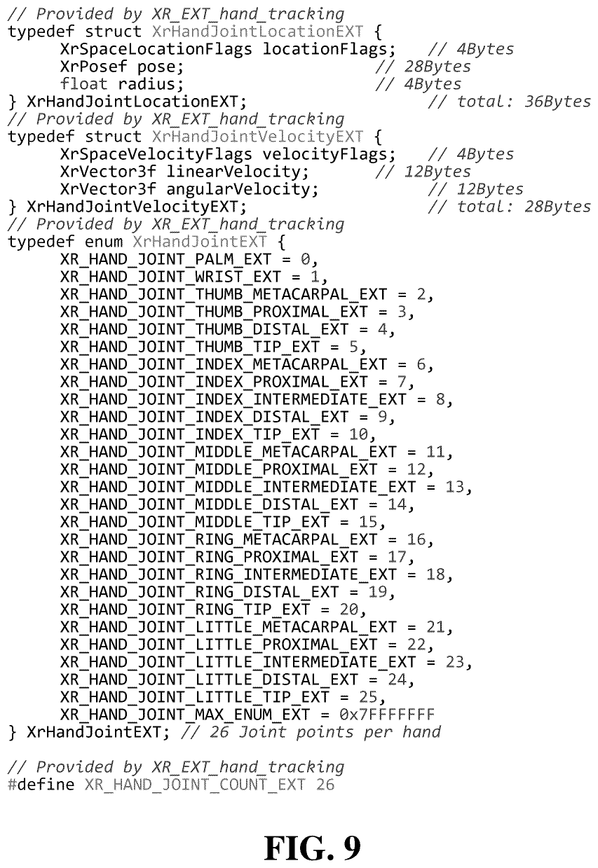

FIG. 9 is an example listing of data structures corresponding to sampled data of individual joints of the OpenXR extension for hand tracking, i.e., OpenXR_EXT_hand_tracking. According to OpenXR_EXT_hand_tracking format, the list of the 52 tracking points consists, in part for each tracked joint, entry of a joint location information and of a joint velocity information, represented in a C++ implementation according to the listing of FIG. 9.

In such examples, the information of tracking one joint corresponds to at least 64 Bytes of information. This implies that for the total of 52 joints, a total of at least 3328 Bytes are necessary to transmit, over a network in real time, the information of the tracked joints, including locations and velocities according to OpenXR_EXT_hand_tracking. The information is further complemented by at least 8 Bytes of metadata indicating the left/right hand tracked object and the mapping of each of the 52 joints information to one of the tracked hand objects. In these examples, assuming a typical MTU size of 1500 Bytes for a network path, it follows that the payload data corresponding to the total of at least 3336 Bytes is split over at least three RTP PDUs using the generic real-time user data payload type and OpenXR_EXT_hand_tracking subprotocol ID, as illustrated within FIG. 8.

In some embodiments, the generic real-time user data payload is additionally padded with a known sequence of bytes such that the total length in bytes of the enclosing RTP PDU is a multiple of 4. This corresponds in effect to the 32-bit alignment specified of RTP PDUs. In an embodiment, the padding bytes are ‘0x00’/NULL bytes.

In some embodiments, the generic real-time user data payload is larger than a maximum transmission unit (MTU) size, e.g., ~1420 bytes for RTP PDU after excluding the RTP header and UDP/IP lower layer overheads, over an established network path. In these embodiments, the generic real-time user data payload is fragmented into fragment units which are split over multiple in-sequence RTP PDUs. In other embodiments, the generic real-time user data payload is much smaller than an MTU size. In an embodiment, more than one generic real-time user data payloads, each smaller than an MTU, can be aggregated as one single payload over one RTP PDU. In another embodiment, the generic real-time user data payload may be multiplexed, according to RTP rules, with data of other media sources (e.g., audio, AAC, video, H.264/H.265) to form a single PDU of an RTP PDU, or alternatively, multiple fragmentation units as payloads of multiple in-sequence RTP PDUs.

One aspect of the disclosure provides a signaling and media description server. The dynamic signaling of the generic real-time user data payload type subprotocol format is dependent on exchanging syntax and semantic elements of the subprotocol format upon session establishment, or equivalently, session update. As detailed previously, in some embodiments, this signaling process is accomplished using SDP messages as offer/answer exchanges during RTP session initialization. These SDP messages carry identifiers, e.g., URIs, or alternatively, URNs, to stored syntax and semantic descriptions. In contrast with typical RTP AVP media formats describing audio-video content, the dynamic real-time user data formats introduced earlier may rely on non-coded content, e.g., OpenXR_EXT_hand_tracking, or serialized encodings of custom content, such as CBOR serialized JSON objects, Base64 serialized JSON objects, flatbuffers serialized raw data structures, or similar. As a result, these data format representations are more dynamic with respect to IETF RTP payload format standardization than typical audio-video codecs (e.g., MPEG-ES, H.264, H.265, VP8/9, AV1 etc.).

In some embodiments, to address the customizable and dynamic nature of the generic real-time user data payload type subprotocol format earlier described, a media description server is used. The media description server constitutes the entry point of the URI of individual payload formats that instantiate subprotocols of the generic real-time user data payload type over RTP PDUs. In addition, the media description server is a storage repository containing Interface Description Language (IDL) resources defining the payload format of user data to be served as subprotocol over the generic real-time user data payload type over one or more RTP PDUs. In one embodiment, such a resource definition of a payload format is formed of machine-readable IDL schema that instructs a general processing CPU, or alternatively, a specialized domain CPU, how to interpret, packetize and depacketize the user data to a payload format corresponding to a subprotocol of the generic real-time user data payload type over one or more RTP PDUs. In another embodiment, the resource definition of a payload format contains a human-readable description as an IDL schema, e.g., based on YAML, JSON, XML, flatbuffers IDL, etc. In such embodiments, at least one of a machine-readable and a human-readable schema description is available within the storage of the media description server repository.

In one embodiment, the IDL schema resource of a payload format contains a description of the fields carrying the information in the payload, including, in part, their syntax within the payload, their semantics for the payload, and their data types (e.g., int32_t, float, double, string, boolean etc.). In addition, the resource definition of the payload defines the payload format representation (e.g., raw bytes, compiled byte encoding—flatbuffers, protocol buffers, or alternatively, any serialized buffers, Base64, CBOR etc.) that can be applied in an embodiment by a RTP packetizer upon packetization, or alternatively, in another embodiment, by a source application pre-RTP packetization. This information is shared with an RTP receiver endpoint over SDP messages in the offer/answer procedure. The resource definition is therefore, in some embodiments, a schema comprising in part of the above elements to determine the format of the subprotocol used over the generic real-time user data payload type. In some other embodiments, such a schema may be an Interface Description Language (IDL).

In one example, an application may implement the OpenXR_EXT_hand_tracking as a subprotocol of the generic real-time user data payload type based on the raw bytes of the listed data structures from FIG. 9. In another example, another application may implement the OpenXR_EXT_hand_tracking as a subprotocol of the generic real-time user data payload type by serialization of the raw bytes of the listed data structures from FIG. 9. In the latter example, the application uses a protocol buffer serialization framework (e.g., Protocol Buffers, Flatbuffers schema based IDL etc.) to serialize the raw bytes, embed additional metadata to the sampled measures (e.g., schema version, payload data attributes, forward/backward compatibility indicators etc.), or alternatively, to compress the raw bytes into a serialized byte representation for transport over the network.

In an embodiment, the media description server is used by an RTP sender and an RTP receiver to negotiate, via SDP offer/answer procedure, whether a subprotocol payload format is supported for an RTP session. This is determined dynamically based on the hosted URI by the media description server. In one embodiment, the sender determines the media description server address, checks, and validates that the media description server contains a required subprotocol format resource description. The validation and check may be implemented, in some examples, based on a stored manifest containing, in part, the version of the subprotocol format resource description. In other examples, the validation and check are further supplemented by a signed manifest. In one implementation, the signature may authenticate and sign the contents of the subprotocol payload format, including its version.

Once the RTP sender has verified the subprotocol format payload resource description hosted by the media description server, the sender initializes the SDP offer and signals this to the receiver. The sender generates the SDP offer, including verified resource description URI and additional format parameters applicable to the subprotocol, as part of the generic real-time user data payload type. In an example, the sender may indicate a desired source clock rate for the timestamp information. In another example, the RTP sender may provide, besides the mandatory URI parameter of the generic real-time user data, payload type additional subprotocol specific parameters. These parameters are indicated similarly to the mandatory ‘uri=<URI>’ parameter and optional ‘subprotocol-id=<ID>’ parameter via the formatting parameter SDP attribute “a=fmtp”.

In such examples, these additional subprotocol specific parameters syntax and semantics are further described and determined by the verified resource description URI. In one implementation listing, which extends the previous SDP offer snippet for the case of an OpenXR_EXT_hand_tracking subprotocol, the parameters ‘format=bytes hand=left+right’ indicate, additionally, that the default raw bytes joint information of both hands are transmitted with left-hand information first, and right-hand information second.

$$…$$

$$m = application 58126 RTP / AVP 200$$

$$a = rtpmap : 200 rt - userdata / 1000$$

$$a = fmtp : 200 uri = https \text{://} example . com / media - descriptions / OpenXR\_EXT \_hand \_tracking . html \#idl subprotocol - id = 52$$

$$format = bytes hand = left + right$$

$$…$$

The sender SDP offer containing a generic real-time user data payload type is received by the RTP receiver. In an embodiment, the RTP receiver processes the SDP offer and verifies that the RTP receiver supports the offered subprotocol format of the generic real-time user data payload type. In some embodiments, this comprises the RTP receiver contacting the media description server and processing the SDP indicated URI to determine the subprotocol format of the generic real-time user data payload type. Once the determination completes and the RTP receiver determines the support for the signaled SDP subprotocol format, the RTP receiver provides an SDP answer. Provided that RTP receiver SDP answer repeats the SDP offer (i.e., the RTP receiver supports the subprotocol format of the SDP offer), the RTP media flow is established for the subprotocol format over the generic real-time user data payload type.

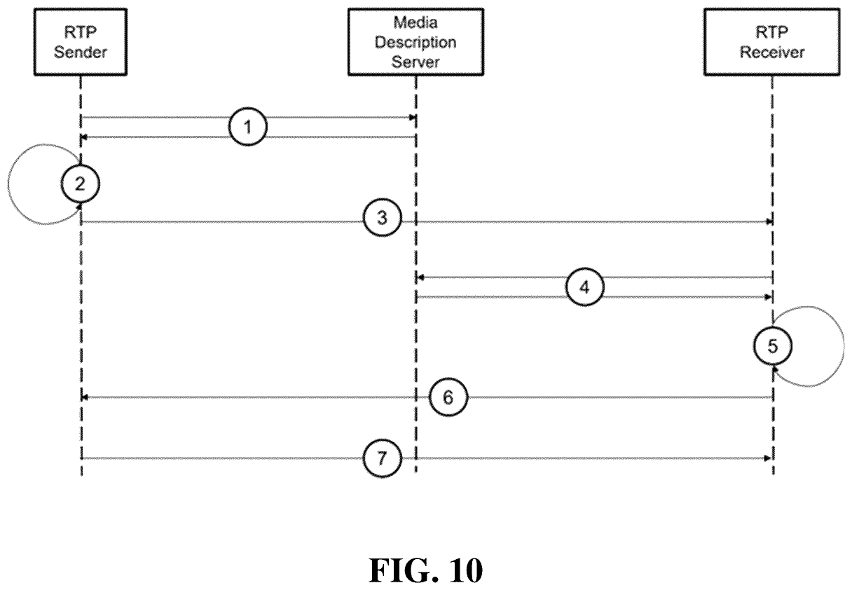

FIG. 10 is a call flow diagram for real-time wireless communication using subprotocol formats for audiovisual media content and non-audiovisual content. To summarize, the steps previously described herein are outlined below as an example call flow illustrated in FIG. 10:
STEP #1: The RTP sender fetches the information of a subprotocol format from the URI by accessing the media description server;
STEP #2: The RTP sender checks the information fetched from the URI and determines an SDP offer comprising at least one generic real-time user data payload type based on the subprotocol format;
STEP #3: The RTP sender sends the determined SDP offer to the RTP receiver, which receives the SDP offer;
STEP #4: The RTP receiver fetches information of the indicated subprotocol format from the media description server, based on the SDP offer signaled URI of the generic real-time user data payload type;
STEP #5: The RTP receiver checks the information fetched from the URI and determines an SDP answer accepting the SDP offer for the subprotocol format of the generic real-time user data payload type;
STEP #6: The RTP receiver sends the SDP answer to the RTP sender;
STEP #7: The RTP communication for the generic real-time user data type comprising of the subprotocol format determined over the SDP offer/answer procedure starts.

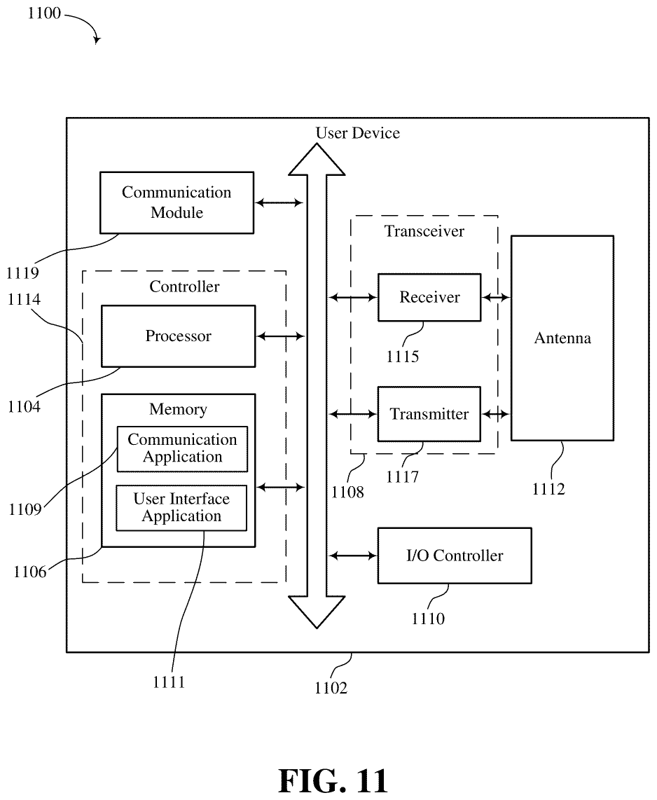

FIG. 11 illustrates an example of a block diagram 1100 of a user device 1102 that performs payload transmission and/or payload reception of real-time communication data that includes at least one of audiovisual media content and non-audiovisual content. The user device 1102 may be an example of a UE 104 (FIG. 1) as described herein. The user device 1102 may support wireless communication with one or more network entities or network devices 102, UEs 104, or any combination thereof. The user device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 1114 includes the processor 1104 that configures the user device 1102 to perform the functionality of the present disclosure. The controller 1114 is communicatively coupled to the memory 1106 to execute program code. Controller 1114 may include dedicated memory solely accessible by the processor 1104, that is a portion of memory 1106. In some implementations, the processor 1104 and the memory 1106 coupled with the processor 1104 may be configured to perform one or more of the functions as a controller 1114 described herein (e.g., executing, by the processor 1104, instructions stored in the memory 1106). In an example, the processor 1104 of a device controller 1114 executes a communication application 1109 to configure UE 104 or user device 120a-120b (FIG. 1) for real-time protocol (RTP) wireless communication. The processor 1104 of a device controller 1114 executes a user interface application 1111 to configure UE 104 or user device 120a-120b (FIG. 1) to generate and/or utilize real-time communication data such as audiovisual media content and non-audiovisual content including spatial interaction data.

The processor 1104 may include an intelligent hardware device (e.g., a general-purpose processor, a DSP, a CPU, a graphics processing unit (GPU), a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the user device 1102 to perform various functions of the present disclosure.

The memory 1106 may include random access memory (RAM) and read-only memory (ROM). The memory 1106 may store computer-readable, computer-executable code including instructions that, when executed by the processor 1104 cause the user device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic input/output (I/O) system (BIOS) which may control basic hardware or software operation such as the interaction with peripheral components or devices.

The I/O controller 1110 may manage input and output signals for the user device 1102. The I/O controller 1110 may also manage peripherals not integrated into the user device 1102. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor 1104. In some implementations, a user may interact with the user device 1102 via the I/O controller 1110 or via hardware components controlled by the I/O controller 1110.

In some implementations, the user device 1102 may include a single antenna 1112. However, in some other implementations, the user device 1102 may have more than one antenna 1112 (i.e., multiple antennas), including multiple antenna panels or antenna arrays, which may be capable of concurrently transmitting or receiving multiple wireless transmissions. The transceiver 1108 may communicate bi-directionally using one or more receivers 1115 and one or more transmitters 1117, via the one or more antennas 1112, wired, or wireless links, as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112. The user device 1102 has the at least one transceiver 1108 that includes at least one receiver 1115 and at least one transmitter 1117 that enable the user device 1102 to communicate with a network entity or network device 102a and to another user device, such as UE 104a (FIG. 1).

The user device 1102 may include a communication module 1119 that is communicatively coupled to the controller 1114. In some implementations, the communication module 1119 may be configured to perform various operations (e.g., receiving, monitoring, transmitting) using or otherwise in cooperation with the receiver 1115, the transmitter 1117, or both. For example, the communication module 1119 may receive information from the receiver 1115, send information to the transmitter 1117, or be integrated in combination with the receiver 1115, the transmitter 1117, or both to receive information, transmit information, or perform various other operations as described herein. Although the communication module 1119 is illustrated as a separate component, in some implementations, one or more functions described with reference to the communication module 1119 may be supported by or performed by a processing subsystem such as controller 1114, the memory 1106, or any combination thereof. For example, the memory 1106 may store code, which may include instructions executable by the controller 1114 to cause/configure the user device 1102 to perform various aspects of the present disclosure as described herein, or the controller 1114 and the memory 1106 may be otherwise configured to perform or support such operations.

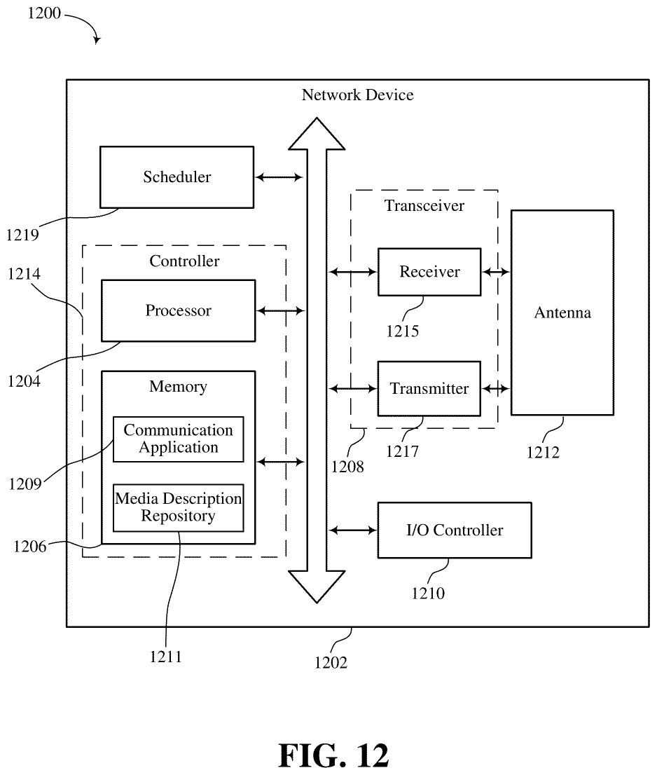

FIG. 12 illustrates an example of a block diagram 1200 of a network device 1202 that provides subprotocol format descriptions to the user devices to support establishment of real-time wireless communication data exchange of at least one of audiovisual media content and non-audiovisual content. The network device 1202 may be an example of a network entity or network device 102 (FIG. 1) as described herein. The network device 1202 may support wireless communication with one or more network entities or network devices 102, UEs 104, or any combination thereof. The network device 1202 may include components for bi-directional communications including components for transmitting and receiving communications, such as a processor 1204, a memory 1206, a transceiver 1208, and an I/O controller 1210. These components may be in electronic communication or otherwise coupled (e.g., operatively, communicatively, functionally, electronically, electrically) via one or more interfaces (e.g., buses).

The processor 1204, the memory 1206, the transceiver 1208, or various combinations thereof or various components thereof may be examples of means for performing various aspects of the present disclosure as described herein. For example, the processor 1204, the memory 1206, the transceiver 1208, or various combinations or components thereof may support a method for performing one or more of the operations described herein.

In some implementations, the processor 1204, the memory 1206, the transceiver 1208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. A controller 1214 includes the processor 1204 that configures the network device 1202 to perform the functionality of the present disclosure. The controller 1214 is communicatively coupled to the memory 1206 to execute program code. Controller 1214 may include dedicated memory solely accessible by the processor 1204, that is a portion of memory 1206. In some implementations, the processor 1204 and the memory 1206 coupled with the processor 1204 may be configured to perform one or more of the functions as a controller 1214 described herein (e.g., executing, by the processor 1204, instructions stored in the memory 1206). In an example, the processor 1204 of a device controller 1214 executes a communication application 1209 to configure network device 1202 to communicate with UE 104 or user device 120a-120b (FIG. 1) for responding to queries for RTP subprotocol format descriptions stored in media description repository 1211.

The processor 1204 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some implementations, the processor 1204 may be configured to operate a memory array using a memory controller. In some other implementations, a memory controller may be integrated into the processor 1204. The processor 1204 may be configured to execute computer-readable instructions stored in a memory (e.g., the memory 1206) to cause the network device 1202 to perform various functions of the present disclosure.

The memory 1206 may include random access memory (RAM) and read-only memory (ROM). The memory 1206 may store computer-readable, computer-executable code including instructions that, when executed by the processor 1204 cause the network device 1202 to perform various functions described herein. The code may be stored in a non-transitory computer-readable medium such as system memory or another type of memory. In some implementations, the code may not be directly executable by the processor 1204 but may cause a computer (e.g., when compiled and executed) to perform functions described herein. In some implementations, the memory 1206 may include, among other things, a basic I/O system (BIOS) which may control basic hardware or software operation such as the interaction with peripheral components or devices.

The I/O controller 1210 may manage input and output signals for the network device 1202. The I/O controller 1210 may also manage peripherals not integrated into the network device 1202. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. In some implementations, the I/O controller 1210 may be implemented as part of a processor, such as the processor 1204. In some implementations, a user may interact with the network device 1202 via the I/O controller 1210 or via hardware components controlled by the I/O controller 1210.

In some implementations, the network device 1202 may include a single antenna 1212. However, in some other implementations, the network device 1202 may have more than one antenna 1212 (i.e., multiple antennas), including multiple antenna panels or antenna arrays, which may be capable of concurrently transmitting or receiving multiple wireless transmissions. The transceiver 1208 may communicate bi-directionally using one or more receivers 1215 and one or more transmitters 1217, via the one or more antennas 1212, wired, or wireless links as described herein. For example, the transceiver 1208 may represent a wireless transceiver and may communicate bi-directionally with another wireless transceiver. The transceiver 1208 may also include a modem to modulate the packets, to provide the modulated packets to one or more antennas 1212 for transmission, and to demodulate packets received from the one or more antennas 1212.

The network device 1202 may include a scheduler 1219 that is communicatively coupled to the controller 1214. In some implementations, the scheduler 1219 may be configured to perform various operations (e.g., receiving, monitoring, transmitting) using or otherwise in cooperation with the receiver 1215, the transmitter 1217, or both. For example, the scheduler 1219 may receive information from the receiver 1215, send information to the transmitter 1217, or be integrated in combination with the receiver 1215, the transmitter 1217, or both to receive information, transmit information, or perform various other operations as described herein. Although the scheduler 1219 is illustrated as a separate component, in some implementations, one or more functions described with reference to the scheduler 1219 may be supported by or performed by a processing subsystem such as controller 1214, the memory 1206, or any combination thereof. For example, the memory 1206 may store code, which may include instructions executable by the controller 1214 to cause/configure the network device 1202 to perform various aspects of the present disclosure as described herein, or the controller 1214 and the memory 1206 may be otherwise configured to perform or support such operations.

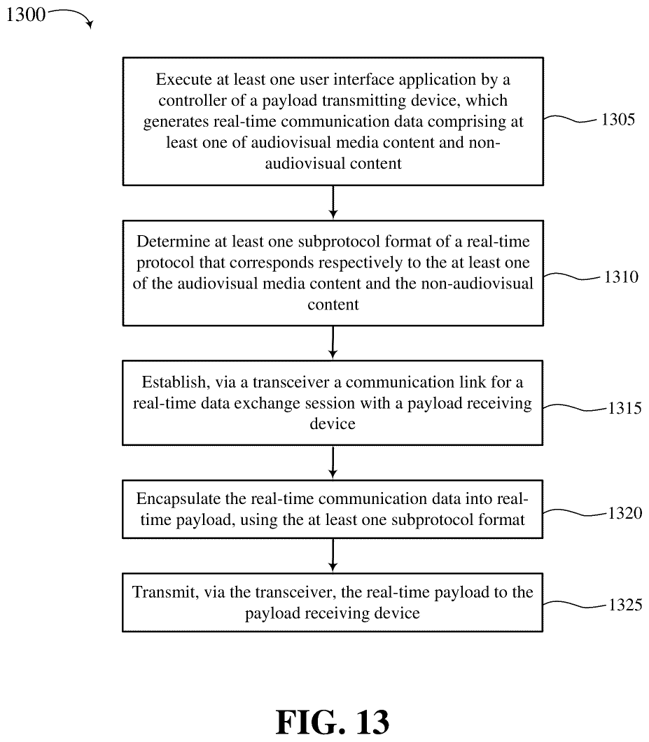

FIG. 13 illustrates a flowchart of a method 1300 for wireless communication at a user device that performs payload transmission of real-time wireless communication data that includes at least one of audiovisual media content and non-audiovisual content. The operations of the method 1300 may be implemented by a device or its components as described herein. For example, the operations of the method 1300 may be performed by a user device such as UE 104 or user device 120-120b (FIG. 1) or user device 1102 (FIG. 11). In some implementations, the user device may execute a set of instructions to control the function elements of the network device to perform the described functions. Additionally, or alternatively, the user device may perform aspects of the described functions using special-purpose hardware.

At 1305, the method 1300 may include executing at least one user interface application by a controller of a payload transmitting device, which generates real-time communication data comprising at least one of audiovisual media content and non-audiovisual content. The operations of 1305 may be performed in accordance with examples as described herein. In some implementations, aspects of the operations of 1305 may be performed by a device as described with reference to FIGS. 1 and 11.

At 1310, the method 1300 may include determining at least one subprotocol format of a real-time protocol that corresponds respectively to the at least one of the audiovisual media content and the non-audiovisual content. The operations of 1310 may be performed in accordance with examples as described herein. In some implementations, aspects of the operations of 1310 may be performed by a device as described with reference to FIGS. 1 and 11.

At 1315, the method 1300 may include establishing, via a transceiver a communication link for a real-time data exchange session with a payload communicating device functioning as a payload receiving device. The operations of 1315 may be performed in accordance with examples as described herein. In some implementations, aspects of the operations of 1315 may be performed by a device as described with reference to FIGS. 1 and 11.

At 1320, the method 1300 may include encapsulating the real-time communication data into real-time payload, using the at least one subprotocol format. The operations of 1320 may be performed in accordance with examples as described herein. In some implementations, aspects of the operations of 1320 may be performed by a device as described with reference to FIGS. 1 and 11.

At 1325, the method 1300 may include transmitting, via the transceiver, the real-time payload to the payload receiving device. The operations of 1325 may be performed in accordance with examples as described herein. In some implementations, aspects of the operations of 1325 may be performed by a device as described with reference to FIGS. 1 and 11.

According to one or more aspects of the present disclosure, determining the at least one subprotocol format for each subprotocol format of the at least one subprotocol format may further include determining a respective uniform resource identifier (URI). The method 1300 may further include accessing, within a repository hosted by a media description server, a respective subprotocol format description identified, at least in part, by the respective URI. The method 1300 may further include encapsulating the real-time communication according to the respective subprotocol format description for the corresponding subprotocol format.

According to one or more aspects of the present disclosure, the method 1300 may include establishing the real-time data exchange session by performing a session description protocol (SDP) offer/answer procedure with the payload receiving device. The method 1300 may further include signaling, via at least one SDP message to the payload receiving device, a mapping of the real-time communication data in the real-time payload to the at least one real-time subprotocol format using the respective URIs.

According to one or more aspects of the present disclosure, the at least one subprotocol format description contains one or more format data items of a group comprising: (i) a version number of the corresponding subprotocol format; (ii) an interface description language (IDL) of the corresponding subprotocol format; (iii) a list of SDP format parameters of the corresponding subprotocol format; and (iv) a list of authoring metadata of the corresponding subprotocol format.

In one or more embodiment, the at least one SDP message includes at least one format parameter specifying a clock rate parameter associated with a real-time protocol timestamping procedure. In one or more particular embodiments, the method 1300 may further include performing the real-time protocol timestamping procedure to timestamp the real-time payload according to the clock rate parameter when encapsulating the real-time communication data into real-time payload.

In one or more embodiments, the real-time payload includes packet data units (PDUs) containing at least one of: (i) a subprotocol identifier field; (ii) a subprotocol attributes field; and (iii) a subprotocol payload data field. In one or more embodiments, the at least one subprotocol format corresponds to the non-audiovisual content, which comprises spatial interaction content. In one or more particular embodiments, the at least one real-time subprotocol format corresponding to the spatial interaction content comprises one or more data types of a group comprising: (i) a user pose description data type; (ii) a user field of view data type; (iii) a user pose or orientation tracking data type; (iv) a user gesture tracking data type; (v) a user body tracking data type; (vi) a user facial expression tracking data type; (vii) a user eye movement tracking data type; and (viii) a location anchor data type.

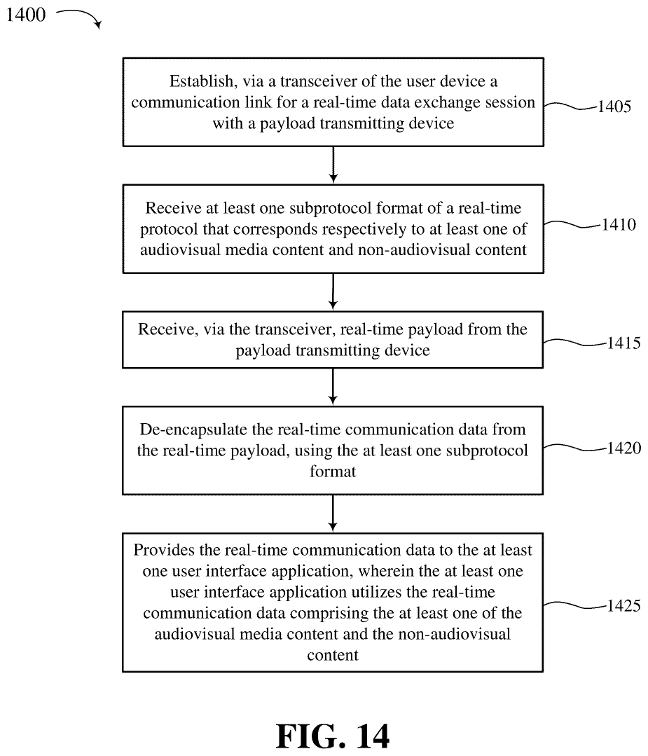

FIG. 14 illustrates a flowchart of a method 1400 for wireless communication at a user device that performs payload reception of real-time wireless communication data including at least one of audiovisual media content and non-audiovisual content, in accordance with aspects of the present disclosure. The operations of the method 1400 may be implemented by a device or its components as described herein. For example, the operations of the method 1400 may be performed by a user device such as UE 104 or user device 120-120b (FIG. 1) or user device 1102 (FIG. 11). In some implementations, the user device may execute a set of instructions to control the function elements of the network device to perform the described functions. Additionally, or alternatively, the user device may perform aspects of the described functions using special-purpose hardware.

At 1405, the method 1400 may include establishing, via a transceiver of the user device, a communication link for a real-time data exchange session with a communicating device functioning as a payload transmitting device. The operations of 1405 may be performed in accordance with examples as described herein. In some implementations, aspects of the operations of 1405 may be performed by a device as described with reference to FIGS. 1 and 11.

At 1410, the method 1400 may include receiving at least one subprotocol format of a real-time protocol that corresponds respectively to at least one of audiovisual media content and non-audiovisual content. The operations of 1410 may be performed in accordance with examples as described herein. In some implementations, aspects of the operations of 1410 may be performed by a device as described with reference to FIGS. 1 and 11.

At 1415, the method 1400 may include receiving, via the transceiver, real-time payload from the payload transmitting device. The operations of 1415 may be performed in accordance with examples as described herein. In some implementations, aspects of the operations of 1415 may be performed by a device as described with reference to FIGS. 1 and 11.

At 1420, the method 1400 may include de-encapsulating the real-time communication data from the real-time payload, using the at least one subprotocol format. The operations of 1420 may be performed in accordance with examples as described herein. In some implementations, aspects of the operations of 1420 may be performed by a device as described with reference to FIGS. 1 and 11.

At 1425, the method 1400 may include providing the real-time communication data to the at least one user interface application, wherein the at least one user interface application utilizes the real-time communication data comprising the at least one of the audiovisual media content and the non-audiovisual content. The operations of 1425 may be performed in accordance with examples as described herein. In some implementations, aspects of the operations of 1425 may be performed by a device as described with reference to FIGS. 1 and 11.

According to one or more aspects of the present disclosure, receiving the at least one subprotocol format for each subprotocol format of the at least one subprotocol format further includes receiving a respective uniform resource identifier (URI). The method 1400 may further include accessing, within a repository hosted by a media description server, a respective subprotocol format description identified at least in part by the respective URI. The method 1400 may further include de-encapsulating the real-time communication according to the respective subprotocol format description for the corresponding subprotocol format.

In one or more particular embodiments, the method 1400 may further include establishing the real-time data exchange session by performing a session description protocol (SDP) offer/answer procedure with the payload transmitting device. The method 1400 may further include receiving, via at least one SDP message from the payload transmitting device, a mapping of the real-time communication data in the real-time payload to the at least one real-time subprotocol format using the respective URIs.

In one or more embodiment, the at least one subprotocol format description contains one or more format data items of a group comprising: (i) a version number of the corresponding subprotocol format; (ii) an interface description language (IDL) of the corresponding subprotocol format; (iii) a list of SDP format parameters of the corresponding subprotocol format; and (iv) a list of authoring metadata of the corresponding subprotocol format. In one or more particular embodiments, the at least one SDP message comprises at least one format parameter specifying a clock rate parameter associated with a real-time protocol timestamping procedure. In one or more specific embodiments, the method 1400 may further include determining a timestamp for the real-time payload according to the clock rate parameter when de-encapsulating the real-time communication data into real-time payload.

In one or more embodiments, the real-time payload comprises packet data units (PDUs) containing at least one of: (i) a subprotocol identifier field; (ii) a subprotocol attributes field; and (iii) a subprotocol payload data field. In one or more particular embodiments, the at least one subprotocol format corresponds to the non-audiovisual content, which comprises spatial interaction content. In one or more specific embodiments, the at least one real-time subprotocol format corresponding to the spatial interaction content comprises one or more data types of a group comprising: (i) a user pose description data type; (ii) a user field of view data type; (iii) a user pose or orientation tracking data type; (iv) a user gesture tracking data type; (v) a user body tracking data type; (vi) a user facial expression tracking data type; (vii) a user eye movement tracking data type; and (viii) a location anchor data type.

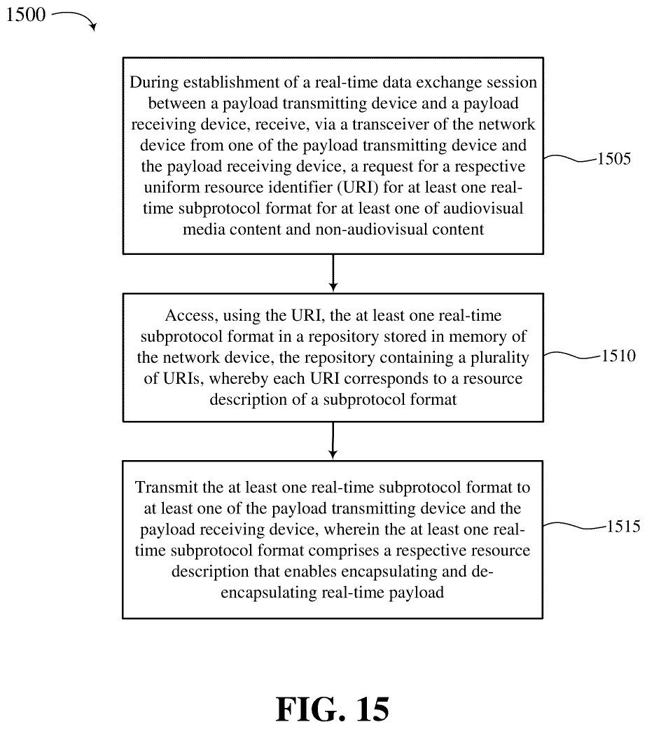

FIG. 15 illustrates a flowchart of a method 1500 for wireless communication at a network device that provides subprotocol format descriptions to user devices to support establishment of real-time wireless communication data exchange, in accordance with aspects of the present disclosure. The operations of the method 1500 may be implemented by a device or its components as described herein. For example, the operations of the method 1500 may be performed by a network device such as network device 102 (FIG. 1) or network device 1202 (FIG. 12). In some implementations, the network device may execute a set of instructions to control the function elements of the network device to perform the described functions. Additionally, or alternatively, the network device may perform aspects of the described functions using special-purpose hardware.

At 1505, the method 1500 may include, during establishment of a real-time data exchange session between a payload transmitting device and a payload receiving device, receiving, via a transceiver of the network device from one of the payload transmitting device and the payload receiving device, a request for a respective uniform resource identifier (URI) for at least one real-time subprotocol format for at least one of audiovisual media content and non-audiovisual content. The operations of 1505 may be performed in accordance with examples as described herein. In some implementations, aspects of the operations of 1505 may be performed by a device as described with reference to FIGS. 1 and 12.

At 1510, the method 1500 may include accessing, using the URI, the at least one real-time subprotocol format in a repository stored in a memory of, or externally accessible to, the network device, the repository containing a plurality of URIs, whereby each URI corresponds to a resource description of a subprotocol format. The operations of 1510 may be performed in accordance with examples as described herein. In some implementations, aspects of the operations of 1510 may be performed by a device as described with reference to FIGS. 1 and 12.

At 1515, the method 1500 may include transmitting the at least one real-time subprotocol format to at least one of the payload transmitting device and the payload receiving device, wherein the at least one real-time subprotocol format comprises a respective resource description that enables encapsulating and/or de-encapsulating real-time payload. The operations of 1515 may be performed in accordance with examples as described herein. In some implementations, aspects of the operations of 1515 may be performed by a device as described with reference to FIGS. 1 and 12.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) comprising:
at least one memory that stores a communication application and at least one user interface application; and
at least one processor communicatively connected to the at least one memory and which is configured to cause the UE to:
executes at least one user interface application, which generates real-time communication data comprising at least one of audiovisual media content and non-audiovisual content for communicating to a payload communicating device functioning as a payload receiving device;
determine at least one subprotocol format that corresponds respectively to the at least one of the audiovisual media content and the non-audiovisual content;
establish a real-time data exchange session with the payload receiving device;
encapsulate, using the at least one subprotocol format, the real-time communication data into a real-time payload; and
transmits the transceiver, the real-time payload to the payload receiving device.

2. The UE of claim 1, wherein, to encapsulate the real-time communication data, the at least one processor is further configured to cause the UE to:
for each subprotocol format of the at least one subprotocol format:
determine a respective uniform resource identifier (URI);
access, within a repository hosted by a media description server accessible via the UE, a respective subprotocol format description identified at least in part by the respective URI; and
encapsulate the real-time communication according to the respective subprotocol format description for the corresponding subprotocol format.

3. The UE of claim 2, wherein the at least one subprotocol format contains one or more format data items of a group comprising: (i) a version number of the corresponding subprotocol format; (ii) an interface description language (IDL) of the corresponding subprotocol format; (iii) a list of SDP format parameters of the corresponding subprotocol format; and (iv) a list of authoring metadata of the corresponding subprotocol format.

4. The UE of claim 2, wherein the at least one processor is further configured to cause the UE to:
establish the real-time data exchange session by performing a session description protocol (SDP) offer/answer procedure with the payload receiving device; and
signal, via at least one SDP message to the payload receiving device, a mapping of the real-time communication data in the real-time payload to the at least one real-time subprotocol format using the respective URIs.

5. The UE of claim 4, wherein the at least one SDP message comprises at least one format parameter specifying a clock rate parameter associated with a real-time protocol timestamping procedure.

6. The UE of claim 5, wherein the at least one processor is further configured to cause the UE to perform the real-time protocol timestamping procedure to timestamp the real-time payload according to the clock rate parameter when encapsulating the real-time communication data into real-time payload.

7. The UE of claim 1, wherein the real-time payload comprises packet data units (PDUs) containing at least one of: (i) a subprotocol identifier field; (ii) a subprotocol attributes field; and (iii) a subprotocol payload data field.

8. The UE of claim 1, wherein the at least one subprotocol format corresponds to the non-audiovisual content comprising spatial interaction content, which comprises one or more data types of a group comprising: (i) a user pose description data type; (ii) a user field of view data type; (iii) a user pose or orientation tracking data type; (iv) a user gesture tracking data type; (v) a user body tracking data type; (vi) a user facial expression tracking data type; (vii) a user eye movement tracking data type; and (viii) a location anchor data type.

9. A user equipment (UE) comprising:
at least one memory that stores a communication application and at least one user interface application; and
a at least one processor communicatively connected to the at least one memory and which is configured to cause the UE to:
establish a real-time data exchange session with the payload communicating device;
receive at least one subprotocol format that corresponds respectively to at least one of audiovisual media content and non-audiovisual content;
receive real-time payload from the payload communication device functioning as a payload transmitting device;
de-encapsulate real-time communication data from the real-time payload, using the at least one subprotocol format; and
provide the real-time communication data to the at least one user interface application, which utilizes the real-time communication data comprising the at least one of the audiovisual media content and the non-audiovisual content.

10. The UE of claim 9, wherein, to receive the at least one subprotocol format, the at least one processor is further configured to cause the UE to:
for each subprotocol format of the at least one subprotocol format:
receive a respective uniform resource identifier (URI);
access, within a repository hosted by a media description server, a respective subprotocol format description identified at least in part by the respective URI; and
de-encapsulate the real-time communication according to the respective subprotocol format description for the corresponding subprotocol format.

11. The UE of claim 10, wherein the at least one processor is further configured to cause the UE to:
receive, via at least one SDP message from the payload transmitting device, a mapping of the real-time communication data in the real-time payload to the at least one real-time subprotocol format using the respective URIs; and
determine a timestamp for the real-time payload according to a clock rate parameter when de-encapsulating the real-time communication data into real-time payload.

12. A method for wireless communication at a user equipment (UE), the method comprising:
executing at least one user interface application by a controller of a payload communicating device functioning as a payload transmitting device, which generates real-time communication data comprising at least one of audiovisual media content and non-audiovisual content;
determining at least one subprotocol format of a real-time protocol that corresponds respectively to the at least one of the audiovisual media content and the non-audiovisual content;
establishing a communication link for a real-time data exchange session with a payload receiving device;
encapsulating the real-time communication data into real-time payload, using the at least one subprotocol format; and
transmitting the real-time payload to a payload receiving device.

13. The method of claim 12, wherein determining the at least one subprotocol format further comprises:
for each subprotocol format of the at least one subprotocol format:
determining a respective uniform resource identifier (URI);
accessing, within a repository hosted by a media description server, a respective subprotocol format description identified at least in part by the respective URI; and
encapsulating the real-time communication according to the respective subprotocol format description for the corresponding subprotocol format.

14. The method of claim 13, further comprising:
establishing the real-time data exchange session by performing a session description protocol (SDP) offer/answer procedure with the payload receiving device; and
signaling, via at least one SDP message to the payload receiving device, a mapping of the real-time communication data in the real-time payload to the at least one real-time subprotocol format using the respective URIs.

15. The method of claim 14, wherein the at least one SDP message comprises at least one format parameter specifying a clock rate parameter associated with a real-time protocol timestamping procedure, the method further comprising:
performing the real-time protocol timestamping procedure to timestamp the real-time payload according to the clock rate parameter when encapsulating the real-time communication data into real-time payload.

16. The method of claim 12, wherein the payload communicating device is configured to function as a payload transmitting device, and the method further comprises:
receiving at least one subprotocol format of a real-time protocol that corresponds respectively to at least one of audiovisual media content and non-audiovisual content;
receiving real-time payload from the payload transmitting device;
de-encapsulating the real-time communication data from the real-time payload, using the at least one subprotocol format; and
providing the real-time communication data to the at least one user interface application, wherein the at least one user interface application utilizes the real-time communication data comprising the at least one of the audiovisual media content and the non-audiovisual content.

17. The method of claim 16, wherein receiving the at least one subprotocol format further comprises:
for each subprotocol format of the at least one subprotocol format:
receiving a respective uniform resource identifier (URI);
accessing, within a repository hosted by a media description server, a respective subprotocol format description identified at least in part by the respective URI; and
de-encapsulating the real-time communication according to the respective subprotocol format description for the corresponding subprotocol format.

18. The method of claim 16, wherein at least one session description protocol (SDP) message comprises at least one format parameter specifying a clock rate parameter associated with a real-time protocol timestamping procedure, the method further comprising determining a timestamp for the real-time payload according to the clock rate parameter when de-encapsulating the real-time communication data into real-time payload.

19. The method of claim 12, wherein the at least one subprotocol format corresponds to the non-audiovisual content comprising spatial interaction content, which comprises one or more data types of a group comprising: (i) a user pose description data type; (ii) a user field of view data type; (iii) a user pose or orientation tracking data type; (iv) a user gesture tracking data type; (v) a user body tracking data type; (vi) a user facial expression tracking data type; (vii) a user eye movement tracking data type; and (viii) a location anchor data type.

20. A network device comprising:
at least one memory that stores a repository containing a plurality of uniform resource identifiers (URIs), whereby each URI corresponds to a resource description of a subprotocol format; and
at least one processor communicatively connected to the at least one memory, and which:
during establishment of a real-time data exchange session between the payload transmitting device and the payload receiving device, receives, via the transceiver from one of the payload transmitting device and the payload receiving device, a request for a respective uniform resource identifier (URI) for at least one real-time subprotocol format corresponding to at least one of audiovisual media content and non-audiovisual content;
accesses, using the URI, the at least one real-time subprotocol format in the repository; and
transmits the at least one real-time subprotocol format to at least one of the payload transmitting device and the payload receiving device, wherein the at least one real-time subprotocol format comprises a respective resource description that enables encapsulating and de-encapsulating of real-time payload.
